(19) United States
(12) Patent Application Publication
(10) Pub. No.: US 2002/0064306 A1
(43) Pub. Date: May 30, 2002

(54) Image encoding method and image encoder

(76) Inventor: Ulrich Pilz, Berlin (DE)

Correspondence Address: VENABLE, BAETJER, HOWARD AND CIVILETTI, LLP, P.O. BOX 34385, WASHINGTON, DC, 20043-9998, US

(21) Appl. No.: 09/934,438

(22) Filed: Aug. 22, 2001

(30) Foreign Application Priority Data
Aug. 22, 2000 (DE) 100 41 037.5

(51) Int. Cl. G06K 9/36; G06K 9/00

(52) U.S. Cl. 382/166

(57) ABSTRACT

Image encoding method for transforming an image into a data bit sequence under resolution into a plurality of pixels individually numbered or provided with pixel coordinates, to which corresponds in each case a luminance value and/or chrominance value from a plurality of predetermined luminance. values and/or chrominance values, each of the luminance values and/or chrominance values occurring in the image, being allocated the numbers or pixel coordinates of the pixels having said luminance value and/or chrominance value.

### DESCRIPTION

The invention relates to an image encoding method as per the preamble of claim 1, and to an image encoder for realizing said method.

Digital image processing, nowadays, as a rule, in short called image processing, is a rapidly developing technical field with manifold and increasingly expanding application possibilities. The spectrum of use extends from destruction-free material and construction tests over automatic control of robots and entire industrial plants, over astronomy, high-energy physics, cartography and meteorology, up to the most diverse biological and medical applications.

Digitization of an image or image encoding may ensue in various ways—photographs or drawings present on a carrier are scanned line-wise, whereas images present as an (analog) video signal may be transformed directly into data bit sequences by analog-to-digital conversion on the electronic way. Basically, digitization comprises two steps, namely of dividing the image model into small partial areas called pixels (screening), and of allocating a luminance or chrominance value to each pixel (quantization).

On the part of the users, higher demands are permanently made with respect to spatial resolution, i.e. the number of pixels per surface unit, and the number of quantization stages of the luminance or chrominance values, for one, and with respect to the amount of image material to be processed and the processing speed, for another. hence, it is the question of an as fast as possible processing of very large image data amounts, so that for a prolonged period of time, intensive developments as to the possibilities of data compression or even data reduction have been conducted. A plentitude of methods is already in practical use in the different fields of application, whereby bit map-oriented methods have to be distinguished from the image encoding as a wave function or of the vector encoding.

The objective of all of these methods is to describe the image to be encoded by as few as possible data to be stored or to be transmitted. For reducing the image data volume, it is also known not to store or transmit less important image details, to combine image data of pixels lying close to each other, to shorten image-describing wave functions by wave portions having minor information content, etc.. The objective of these methods for image data compression is to save storage space requirement or to accelerate image data transmission, respectively.

Starting point of the essential known methods for image description is a so-called bit map, which is obtained for each pixel by dividing the image into a XY matrix of pixels, and by allocation of a storage area, where a luminance value and if necessary, a chrominance value are memorized as digital values. Hereby, the pixel is allocated that luminance or chrominance value from a predetermined sequence of discret luminance or chrominance values, which coincides most with the actual chrominance value.

With this procedure applies: An image is a fixed number of pixels, each having allocated a luminance value and/or chrominance value. The number of the used pixels, for one, and the number of the used luminance and chrominance gradations, for another, differ very considerably in dependence of the specific application. Independent of the actual determination of the corresponding values, these methods experience principal limitations with respect to the compressibility or reducibility of the image data volume.

The invention therefore is based on the objective task of providing an image encoding method having essentially improved image data compression possibilities or image data reduction possibilities, respectively. Moreover, a corresponding powerful and fast image encoder is intended to be proposed. This objective task is solved with respect to the process aspect by an image encoding method having the features of claim 1, and with respect to its device aspect by an encoder having the features of claim 10.

The inventive method, which can in short be designated DLC. method (DLC: Dynamic Luminance and Chrominance. Encoding/Decoding), includes the following fundamental processing rule: An image is a fixed—yet independent of the image content—number of chrominance and luminance values, which are allocated the pixels obtained by screening.

For encoding an image according to this method, it is started —departing from introduced techniques—in particular from a bit map file of already digitized image data. During the realization of the method, it is first analyzed, which luminance and chrominance values are present at all in the image. Non-occurring luminance and chrominance values are eliminated from the processing-relevant luminance and chrominance scale, since these are not required for the image description. Alone hereby already, it is possible to considerably reduce the volume of the data bit sequence or “DLC file” (in dependence on the image content) forming the method result, without an information loss occurring. The chrominance or luminance values required for the image description are subsequently allocated the pixel coordinates or pixel numbers defining those pixels, in which the respective chrominance or luminance value is present.

In the most common realization of conventional image processing methods, the pixels are allocated pixel coordinates as value pairs of Cartesian coordinates (X and Y parameters) The pixels accordingly are indicated in the data bit.sequence generated according to this method as value pairs, whereas.the luminance or chrominance values, to which the pixels are allocated, are preferably encoded as single numerical values. In another realization—which in practice surely is less important—the pixels are allocated polar coordinates (r and Φ values)—and here, as well, the luminance and chrominance values are preferably encoded as single numerical values.

In a preferred manner, the pixels allocated to the arising

luminance and chrominance values are encoded in the data bit sequence in a predetermined order of the luminance and chrominance values, whereby in one suitable realization, all pixels allocated to a determined luminance or chrominance value, are in each case preceded by a value characterizing the distance to the preceding luminance and chrominance value. This proceeding furnishes special advantages with images, which are particularly “gappy” with respect to the luminance and chrominance scale. In place of the mentioned distance values, however, the absolute luminance or chrominance values may as well be encoded in the data bit sequence, said absolute values being in each case followed by the associated pixel numbers or pixel coordinates.

As a simplified example herefor, the image data encoding for an image having 649×480 pixels and 128 chrominance values will be sketched in the following. It is to be understood that for a larger number of pixels and a more finely gradated colour range, as well as for the (additional or sole) encoding of luminance values, the analog proceeding can be carried out.

The following allocation of selected chrominance values and pixels would apply to the image:

| Chrominance value | pixels | (X/Y) | | | |
|---|---|---|---|---|---|
| 1 | 88/78 | 78/88 | 78/89 | | |
| 2 | | | | | |
| 3 | | | | | |
| 4 | | | | | |
| 5 | 55/55 | | | | |
| . . . | | | | | |
| 22 | 27/56 | 27/57 | 66/89 | | |
| 23 | 17/88 | 18/78 | | | |
| 128 | 67/78 | 67/90 | 123/89 | 126/67 | 200/56 |

As a first step of data compression, storage or transmission of chrominance values which have no pixels allocated, are renounced of. Therewith, the DLC file presents itself as follows:

| | | | | | |
|---|---|---|---|---|---|
| 1 | 88/78 | 78/88 | 78/89 | | |
| 5 | 55/55 | | | | |
| . . . | | | | | |
| 22 | 27/56 | 27/57 | 66/89 | | |
| 23 | 17/88 | 18/78 | | | |
| 128 | 67/78 | 67/90 | 123/89 | 126/67 | 200/56 |

Next, according to an algorithm implemented in the image encoder, as well as in the image decoder, a sequence of numbers is generated, in which the numbers separated from each other by a slash designate the X and Y coordinate of a pixel, whereas single numbers designate a distance to preceding chrominance values (“leap in the chrominance value”). The following sequence of numbers arises: 88/78 78/88 78/89 4 55/55 17 27/56 27/57 66/89 1 17/88 17/78 105 67/78 67/90 123/89 126/67 200/56.

An additional possibility for data compression ensues, when within one image, a determined number of partial images is defined according to a predetermined algorithm, e.g. two partial images (left/right) or four partial images (left top/right top/left bottom/right bottom), and when in the image encoder and decoder software the declaration is implemented that within the sequence of numbers (data bit sequence), the description of the next partial image will start, when after ascending X and Y coordinates lower values arise again. This as well shall be explained by means of an example:

↓ here start coordinates
of a new partial image

12/45 34/78 67/89 123/124 28/67 67/89

| | | | |
|---|---|---|---|
| ↓ | skip | ↓ | here start |
| | partial image | | coordinates |
| | | | of a new |
| | | | partial image |

12/45 34/78 0/0 67/89 123/234 156/245 28/67 67/87

An essential possibility for data reduction ensues by the fact that luminance values and/or chrominance values, which have a number of pixels allocated falling below a determined threshold value, are not encoded in the DLC file. In the simplest case, the corresponding pixels no longer appear at all in the reduced data bit sequence. This proceeding its refined by the fact that those pixels, the luminance and/or chrominance values of which are not encoded, are in each case allocated to the next adjacent luminance and/or chrominance value. The first mentioned possibility, which is sitpler as far as encoding is concerned, may be refined in that those pixels on the decoder side, for which no luminance or chrominance value was furnished, are allocated a value calculated from information on the surrounding pixels.

Hereby, for restricting the consequences of information loss, it is possible to define protected image areas. If a pixel originates from this specifically defined area, implemented data reduction procedures are not at all applied herefor or only pursuant to a moderated mode. The relevant information has only to be present in the image encoder and has not to be communicated to the decoder, so that this procedure does not require additional transmission capacity.

The above-mentioned process steps and aspects comprise in each case in the realization of an image encoder an equivalent. in device in the hardware and software configuration. The inventive image encoder comprises in particular a pixel allocation means for realizing the mentioned allocation of numbers or coordinates of pixels to the separately arising luminance or chrominance values. Moreover, it comprises in particular a luminance value/chrominance value detection means for examining the image—or a primary bit map—for occurrence of the individual luminance value and/or chrominance value from a predetermined plurality of such values.

Finally, the image encoder in particular comprises a digital input for a primary data bit sequence (bit map), and a digital output for the secondary—compressed and, if necessary, reduced—data bit sequence (DLC file).

In a realization enabling the above-mentioned data reduction by non-encoding rarely occurring luminance or chrominance values, the image encoder comprises a luminance threshold value discriminator/chrominance threshold value discriminator, and a counter means connected to the latter and the luminance detection means/chrominance detection means for ascertaining the number of pixels allocated by a determined luminance value or chrominance value, and for discriminating said nuniber of pixels at a predetermined (programmed) threshold value.

To these components, an adjacent value allocation means is connected in a further specific realization, which allocates the next adjacent luminance value or chrominance value of the primary value scale to those pixels, the original luminance or chrominance value of which are not encoded due to the small number of allocated pixels.

In a further specific realization, the image encoder comprises an image dividing means becoming effective in the initially mentioned step of screening the image, and which either defines an image area with high priority (or even several of such image areas) and/or subdivides the image into partial images with in each case separate pixel numbering or pixel coordinate allocation.

The realization of the invention is not restricted to these aspects and the above-mentioned simplified examples, rather, it can be realized within the framework of the enclosed claims in a multitude of modifications being within the scope of the skilled person's proceeding.

Also, the use of numerous methods already known for data reduction and data compression is reasonably possible by means of the DLC method for the purposes of an utmost large reduction of the data amount. Thus, for example, the known method of run-length coding represents one possibility of further reducing the number of bits to be stored or transmitted. Well suited for combination with the DLC method is the method of forming image clusters, in which the transmission of adjacent pixels having equal luminance or chrominance information ensues by formation of a cluster, which can be described in an abbreviated manner as a condensation of these pixels.

1. Image encoding method for transforming an image into a data bit sequence under resolution into a plurality of pixels individually numbered or provided with pixel coordinates, to which corresponds in each case a luminance value and/or chrominance value from a plurality of predetermined luminance values and/or chrominance values, characterized in that each ot the luminance values and/or chrominance values occurring in the image, are allocated the numbers or pixels coordinates of the pixels having said luminance value and/or chrominance value.

2. Image encoding method according to claim 1, characterized in that in a first step, the image is examined as to which of the predetermined plurality of luminance values and/or chrominance values occurs in the image, and in a second step, each of the detected luminance values and/or chrominance values are allocated the numbers or pixel coordinates of the pixels having said luminance value and/or chrominance value.

3. Image encoding method according to claim 1, characterized by the realization as processing of a primary data bit sequence for obtaining a secondary, in particular compressed or reduced data bit sequence, luminance values and/or chrominance values having no pixel allocated being not encoded in the secondary data bit sequence.

4. Image encoding method according to claim 3, characterized in that the pixels are allocated pixel coordinates as value pairs of Cartesian coordinates or polar coordinates, and the pixel coordinates are indicated in the secondary data bit sequence as value pairs, whereas the luminance values and/or chrominance values with which the pixels are associated, are encoded as individual numerical values.

5. Image encoding method according to claim 1, characterized in that the pixels allocated to the occurring luminance values and/or chrominance values are indicated in a predetermined order of the luminance values and/or chrominance values, the pixels allocated to a determined luminance value and/or chrominance value being in each case preceded by a value characterizing the distance to the preceding luminance value and/or chrominance value.

6. Image encoding method according to claim 1, characterized in that for data reduction, those luminance values and/or chrominance values having a number of pixels allocated falling below a determined threshold value, are not encoded.

7. Image encoding method according to claim 6, characterized in that those pixels, the luminance values and/or chrominance values of which are not encoded, are allocated to the next adjacent luminance value and/or chrominance value.

8. Image encoding method according to claim 6, characterized in that particularly relevant parts of an image are predetermined, in which the non-encoding of those luminance values and/or chrominance values is suppressed, which have a number of pixels allocated falling below a determined threshold value.

9. Image encoding method according to claim 1, characterized in that the image is subdivided into partial images in a predetermined order, in which partial images the pixels are in each case separately numbered or provided. with pixel coordinates.

10. Image encoder for realizing the image encoding method according to claim 1, characterized by a pixel allocation means for allocating pixels having a predefined luminance value and/or chrominance value to the corresponding luminance value and/or chrominance value.

11. Image encoder according to claim 10, characterized by a luminance value/chrominance value detection means connected to an input of the pixel allocation means for examining, in particular in a scanning manner, the image for the occurring luminance values and/or chrominance values.

12. Image encoder according to claim 10, characterized by a digital input for receiving a primary data bit sequence, and a digital output for outputting a secondary, in particular compressed or reduced data bit sequence.

13. Image encoder according to claim 10, characterized by a luminance/chrominance threshold value discriminator and a counter means connected to the output of the pixel allocation means for counting the pixels allocated to the individually occurring luminance values and/or chrominance values, which counter means is connected to the input of the luminance/chrominance threshold value discriminator the luminance(chrominance threshold value discriminator and the counter means cooperating in such a manner that luminance values and/or chrominance values having a nomber of pixels allocated falling below a predetermined threshold value, are not encoded and are not outputted.

14. Image encoder according to claim 13, characterized by an adjacent value allocation means connected to the luminance/chrominance threshold value discriminator for allocating to the next adjacent luminance and/or chrominance value those pixels, the luminance values and/or chrominance values of which are not encoded due to falling below the threshold value.

15. Image encoder according to claim 10, characterized by an image dividing means for determining restricted, particularly relevant parts of an image and/or for subdividing the image into partial images, in which the pixels are in each case separately numbered or provided with pixel coordinates in a determined order.
